(19) United States
(12) Patent Application Publication
(10) Pub. No.: US 2004/0102348 A1
(43) Pub. Date: May 27, 2004

(54) Process for stain removal

(76) Inventors: David J. Schneider, Union, KY (US); Charles A. Schneider, Villa Hills, KY (US)

Correspondence Address: Donald R. Bahr, 2608 Merida Lane, Tampa, FL, 33618, US

(21) Appl. No.: 10/717,756

(22) Filed: Nov. 20, 2003

Related U.S. Application Data
(60) Provisional application No. 60/428,543, filed on Nov. 22, 2002.

(51) Int. Cl. C11D 1/00

(52) U.S. Cl. 510/283

(57) ABSTRACT

Chloramine-T has been used as a biocide for over one hundred years. Chloramine-T is also useful as a stain removal agent. This invention is concerned with a process whereby stains on a variety of substrates may be removed by treating a stained area of a substrate with a solution of Chloramine-T. In one embodiment a stained substrate is sprayed with a solution of Chloramine-T. The stained area may also be treated with a slurry or paste of Chloramine-T in order to effect stain removal. Solutions of Chloramine-T have the ability to remove undesirable stains without adversely affecting the substrate i.e. a piece of clothing.

### RELATED APPLICATIONS

This application claims priority of U.S. Provisional Application S. No. 60/428,543 Filed Nov. 22, 2002.

### BACKGROUND OF THE INVENTION

This invention is concerned with the removal of stains from various substrates, stain removal is effected in such a manner that the substrate is not degraded. An important embodiment of this invention is the removal of stains from textiles and in particular clothing, carpeting and bedding.

In its broadest sense the dyeing of a substrate can be considered to be a reaction of a chemical compound with a substrate wherein the color of the substrate is altered by the compound. In the usual sense the color of a substrate is altered in order to achieve a particular result i.e. a textile is reacted with a chemical compound (a dye) in order to change the color of the textile.

Almost as soon as man learned how to weave cloth man further learned how to decorate the cloth by changing its color by dyeing. The most basic dyeing process consisted of soaking the cloth, i.e. a piece of clothing, in a solution of a natural dye. Examples of natural dyes, are compounds which are obtained from animal or plant sources.

Most dyes used today are synthetic. The dyeing of a substrate is usually intentional such as the dyeing of fabric from which clothing is subsequently manufactured.

The dyeing of a substrate can also be accidental an hence undesirable. An area of a substrate which has a section which has been unintentionally altered, by dyeing, is referred to as a stain. This invention is concerned with the removal of stains from a variety of substrates. An important use of this invention is the removal of undesirable stains from institutional items such as uniforms worn by food service workers, health care workers and hospital and hotel bedding. Another area where this invention is useful is the removal of pet stains from carpet.

Stains in accordance with this invention are removed by exposure of the stain to solutions of Chloramine-T.

### PRIOR ART

Stain removal in the prior art has been effected by exposing a stained substrate to a bleaching agent or to sunlight. Sunlight is the original bleaching agent which is one reason why clothes were hung out to dry. In the last eighty years solutions of sodium hypochlorite have become widely accepted as bleaching agents. These solutions are commonly referred to as bleach. While the use of bleach has become widely accepted, the use of bleach is often troublesome as it often detrimentally affects the substrate from which the stain is being removed.

When Chloramine-T is used as a stain removal agent, in accordance with this invention, the substrate is not affected

### BRIEF DESCRIPTIONS OF THE INVENTION

This invention deals with a process for removing stains from a wide variety of substrates such as wood, polymers, rubbers, textiles, carpets, etc. The process of this invention is particularly concerned with the removal of organic stains such as food and body fluid stains from clothing and bedding.

Stain removal is widely used in the carpet cleaning and the laundry arts. A particular area of concern is the removal of food stains from institutional clothing, i.e. the clothing worn by food service workers. Further the invention is useful in the removal of body fluid stains from bedding and clothing.

Bleach, is a solution of sodium hypochlorite and is the most widely used stain remover. Solutions of sodium hypochlorite have been used, for this purpose, for over 80 years. In the case of clothing, sodium hypochlorite works well provided the clothing is white. In the past almost all institutional clothing was white. In recent years the use of colored institutional clothing has become widespread. The bleaching of stains from colored institutional clothing has proved to be troublesome, as the process which is used to remove the stain often affects the base color of the substrate. For example in the case of a colored food service uniform with a ketchup stain, the ketchup stain may be removed however, the color of the uniform around the stain is often altered. In this case by use of bleach as a stain removal agent, the stain is removed however, the uniform was ruined.

Solutions of sodium hypochlorite function as stain removal agents, as a result of their ability to release active chlorine in the form of the Cl+ ion. The Cl+ ion released by sodium hypochlorite is very ionic and hence its action is very harsh. It is this harsh action that affects both the color of the stain and the substrate.

This invention is concerned with the use of solutions of Chloramine-T as stain removal agents. Chloramine-T, when it goes into solution, in the presence of organic molecules, releases active chlorine on demand.

The latent Cl+ ion released by Chloramine-T has been found to be strong enough to bleach a stain, as the stain is not fast. The latent ion released by Chloramine-T is not strong enough to affect the color of a dyed substrate. That is, in accordance with this invention, the latent Cl+ ion released by Chloramine-T is strong enough to remove a stain on a colored substrate, but not strong enough to affect the color of the dyed substrate. This selectively is particularly true if the base substrate has been dyed with a fast dye.

The use of Chloramine-T as a stain removal agent is particularly useful in the domestic and industrial laundry arts and in the area of carpet and upholstery cleaning. This invention can be used on stains which are produced by both inorganic and organic stain agents. Solutions of Chloramine-T are particularly suited for use on food stains and body fluid stains such as stains resulting from wine, blood, urine etc.

### OBJECTS OF THE INVENTION

An object of this invention is an effective way to remove stains from a substrate. Another object of this invention is a process whereby food stains may be removed from clothing.

Still another object of this invention is a process of removing organic stains from clothing and bedding with a solution which incorporates the latent Cl+ ions as an active agent.

A further object of this invention is an effective process for the removal of organic stains from institutional clothing and bedding wherein the active component is Chloramine-T.

### DESCRIPTION OF THE PREFERRED EMBODIMENT

As per the above discussion the subject invention deals with a process whereby inorganic and organic stains may be removed from substrates using Chloramine-T as a stain removal agent.

The use of bleaching agents to bleach a stain from a substrate is and has been the state of the art for at least eighty years.

The most common bleaching agents are solutions of sodium hypochlorite. Solutions of sodium hypochlorite are commonly referred to as bleach. These solutions are effective in that they contain an ionic form of the Cl+ion. Because the Cl+ ion is ionic it is very effective as a bleaching agent and capable of removing color from a substrate. That is the ionic Cl+ion is capable of removing color from a substrate particularly textile substrates. This presents a problem as both the desirable and undesirable coloration is removed from the target substrate.

For example, if a colored uniform incorporates a food stain, solutions which incorporate the ionic Cl+ ion, while removing the food stain will also affect the color of the base uniform. If the color of the base uniform is selectively affected the uniform is unsightly and hence ruined. This problem is acute where the stain removal agent is selectively applied to a stained area i.e. the spraying of a stain removal agent onto a clothing area which includes a food stain.

In accordance with this invention a target stain is removed from a substrate by applying a solution of Chloramine-T to the stained area. In solution Chloramine-T disassociates to form an active latent Cl+ion.

Because the active Cl+ion is latent its effect on the substrate is minimal and yet it is strong enough to remove the stain. Because the base substrate is colored with a fast dye, the substrate is better able to resist change, as is to be compared with a stained area. Chloramine-T has the ability to remove the coloration from the stained area without altering the coloration of the surrounding substrate.

For example if a colored uniform incorporates a blood stain, when a solution of Chloramine-T is applied to the stain, the blood stain is removed without discoloration of the colored uniform.

Chloramine-T has been known and used for over one hundred years. Because it produces the active Cl+ion it has been widely used as a biocide.

The structure of Chloramine-T is as follows:

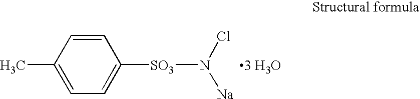

When Chloramine-T goes into solution it disassociates to form the latent Cl+ion. As a result of this disassociation the action of the resulting Cl+ion is strong enough to remove the stain coloration from the substrate but not strong enough to remove the color from the base substrate. For example the Chloramine-T will remove a blood stain from a nurses colored uniform, but it will not remove the base color of the uniform.

In accordance with this invention the latent Cl+ ions produced by Chloramine-T are converted into active Cl+ ions on demand. The applicants are not sure of this kinetics of the process of this invention. It is felt that Chloramine-T will react only when the energy requirements are such that the latent Cl+ ion can be released.

The easiest and most effective way of applying the Chloramine-T to a substrate is to spray the stained area with a solution of Chloramine-T, containing an effective concentration of Chloramine-T.

The solution of Chloramine-T is then allowed to stand on the substrate for an effective period of time. This effective period of time can be from about 5 min. to about 12 hours or longer.

For use in accordance with this invention the stain removal solution which is used in the process of this invention must incorporate an effective amount of Chloramine-T. Solutions containing from about 0.05 to about 5 weight percent of Chloramine-T have been found to be effective in stain removal.

A more preferred concentration for Chloramine-T for use in this invention is from about 0.25 to about 2 weight percent. A most preferred concentration for Chloramine-T for use in this invention is from about 0.5 to about 1.0 weight percent, with a most preferred concentration for Chloramine-T being 0.75 weight percent.

The performance of Chloramine-T solutions in stain removal formulations, may be further enhanced by additives to these solutions such as phosphates i.e. sodium phosphate, wetting agents buffering agents etc.

As to the three types of wetting agents, cationic, anionic and nonionic, for use in this invention anionic wetting agents are most preferred, followed by non anionic wetting agents with cationic wetting agents being least preferred.

Examples of suitable wetting agents which are useful in accordance with this invention are: Avanel S-74 and Dodecylbenzenesulfonic acid (DDBSA) and Linear Alkylbenzene Sulfonic Acid's (LABSA).

The most preferred wetting agent for use in this invention is an anionic wetting agent sold under the trademark Avanel S-74 by the BASF Chemical Co. of Mt. Olive, N.J. The applicant believes that Avanel S-74 is Ethoxylated ROH suffonate, where R is CH₃, CH₃ CH₂ or CH₂ CH₂.

An effective amount of the desired wetting agent is used. Solutions containing from about 0.05 to about 2 weight percent of a wetting agent have been found to be effective in accordance with this invention.

The presence of small amounts of phosphates have been found to be effective in enhancing stain removal in accordance with this invention. Suitable phosphates for use in this invention are: sodium phosphate, disodium phosphate, trisodium phosphate, sodium triploy phosphate, tetra sodium pyro phosphate, potassium phosphate, dipotassium phosphate, tripotassium phosphate, and potassium triploy phosphate. The preferred phosphate salt for use in this invention is trisodium phosphate.

In addition to being an excellent stain removal agent Chloramine-T, due to its biocidal and fungicidal properties, kills any bacteria and/or fungus as may be contained on the substrate from which the stain is being removed. Further Chloramine-T after removing the stain leaves traces of Chloramine-T on the substrate which inhibits future bacterial and/or fungicidal activity.

While Chloramine-T is the preferred source for the latent Cl+ion in accordance with this invention, Chloramine-B can also be used as a source for the latent Cl+ion. Examples of other suitable sources for the latent Cl+ion are trichloromelamine, Hexachloromelamine and Dichloramine-T.

In addition to effecting stain removal by spraying a substrate with a solution of Chloramine-T stain removal may be effective in accordance with this invention by applying a slurry paste of Chloramine-T to a stain.

For use in this invention aqueous solutions of Chloramine-T are preferred however, solutions which are based on other solvents may be used.

The following examples will illustrate the stain removal in accordance with the subject invention. These examples are given for purposes of illustration and not for purposes of limiting this invention.

### EXAMPLES

In Examples 1-12 clean samples of cotton T shirt material measuring 4×4″ were prepared. Test samples and control samples were then prepared. The control samples were stained, dried and then washed. The test samples were stained, dried and then saturated with a solution comprising 0.8% Chloramine-T, 0.2% sodium biocarbonate and 0.03% of a wetting agent sold under the trademark Avanel S-74 by the BASF Chemical Co. of Mt. Olive, N.J. The applicant believes that Avanel S-74 is Ethoxylated ROH sulfonate, where R is Ch₃, CH₃ CH₂ or CH₃ CH₂ CH₂.

All samples were then washed in an automatic washer regular cycle, warm wash, cold rinse and air dried.

The data for these test is as follows:

### Example 1

Control stain material crushed blueberries, blue color, stain remained.

### Example 2

Stained one side only, stained material crushed blueberries over 80% of the stain was gone, blue color completely gone.

### Example 3

Stained both sides, stain material blue berries, over 50% of the stain gone blue color completely gone.

### Example 4

Control, stain material mustard no change in stain after washing stain remained bright.

### Example 5

Stained one side only, stain material mustard, stain faded, however still visible.

### Example 6

Stained two sides, stain material mustard, stain less bright, however faded.

### Example 7

Control, stain material ketchup, stain faded but still visible.

### Example 8

Stained one side only, stain material ketchup stain completely gone.

### Example 9

Stained two sides, stain material ketchup stain almost completely gone.

### Example 10

Control, stain material soy sauce, stain very faded but still visible.

### Example 11

Stained one side, stain material soy sauce, stain completely gone.

### Example 12

Stained two sides, stain material soy sauce, stain completely gone.

### Example 13

A cotton sheet was found to contain stains resulting from human blood.

After an initial washing, a wet water paste of powdered Chloramine-T was was prepared and applied to both sides of the stain for six hours. The sheet was then rewashed, the blood stain was completely removed.

The above description is illustrative of modifications that can be made without departing from the present invention, the scope of which is to be limited only by the following claims.

What is claimed is:

1. A process for stain removal, comprising the steps of treating a stained area of a substrate with a solution of Chloramine-T, and allowing the solution to stand on the stained area for an effective period of time.

2. The process of claim 1 wherein the effective period of time is from about 5 minutes to about 12 hours, and the solution contains from about 0.05 to about 5 weight percent Chloramine-T.

3. The process of claim 1 wherein the solution of Chloramine-T further incorporates an effective amount of a wetting agent.

4. The process of claim 2 wherein the solution of Chloramine-T further incorporates an effective amount of a wetting agent.

5. The process of claim 3 wherein solution of Chloramine-T further incorporates an effective amount of a sodium or potassium phosphate salt.

6. The process of claim 4 wherein the concentration of Chloramine-T further incorporates an effective amount of a sodium or potassium phosphate salt.

7. The process of claim 3 wherein the concentration of Chloramine-T is from about 0.5 to about 3 weight percent, and the concentration of the wetting agent is from about 0.05 to about 1.0 weight percent and the wetting agent is anionic wetting agent.

8. The process of claim 4 wherein the concentration of Chloramine-T is from about 0.5 to about 3 weight percent, and the concentration of the wetting agent is from about 0.05 to about 1.0 weight percent and the wetting agent is a anionic wetting agent.

9. The process of claim 5 wherein the concentration of Chloramine-T is from about 0.2 to about 2 weight percent and the wetting agent is a nonionic wetting agent.

10. A process for removing a stain from an article of clothing which comprises the steps applying to the stained area, an aqueous solution containing from about 0.5 to about 3 weight percent Chloramine-T, from about 00.5 to about 1.0 weight percent of a nonionic wetting agent and from about 0.5 to about 5 weight percent of a sodium phosphate salt.

11. The process of claim 10 wherein the wetting agent is Avanel S-74 as is sold by BASF Chemical Co. of Mt. Olive, N.J. and the sodium phosphate salt is trisodium phosphate.
